(19) United States
(12) Patent Application Publication
(10) Pub. No.: US 2024/0425397 A1
(43) Pub. Date: Dec. 26, 2024

(54) Data-knowledge-driven Approach for Optimal Control of Wastewater Treatment Processes

(71) Applicant: BEIJING UNIVERSITY OF TECHNOLOGY, BEIJING (CN)

(72) Inventors: Hong-Gui Han, BEIJING (CN); Lin-lin Zhang, BEIJING (CN); Jun-Fei Qiao, BEIJING (CN)

(21) Appl. No.: 18/827,659

(22) Filed: Sep. 6, 2024

Related U.S. Application Data
(63) Continuation-in-part of application No. 17/334,535, filed on May 28, 2021, now abandoned.

(51) Int. Cl. C02F 3/00; C02F 1/00; C02F 3/30

(52) U.S. Cl. CPC C02F 3/006; C02F 3/305; C02F 2001/007; C02F 2209/006; C02F 2209/14; C02F 2209/15; C02F 2209/225; C02F 2301/08

(57) ABSTRACT

A data-knowledge driven multi-objective optimal control method for municipal wastewater treatment process belongs to the field of wastewater treatment. To balance the energy consumption and effluent quality, a data driven multi-objective optimization model, including energy consumption model and effluent quality model are established to obtain the nonlinear relationship along energy consumption, effluent quality and manipulated variables. Meanwhile, a multi-objective particle swarm optimization algorithm, based on evolutionary knowledge, is proposed to optimize the set-points of nitrate nitrogen and dissolved oxygen. Moreover, the proportional integral differential (PID) controller is designed to track the set-points. Then the effluent quality can be improved and the energy consumption can be reduced.

### CROSS-REFERENCE TO RELATED APPLICATIONS

This application is a continuation-in-part of application Ser. No. 17/334,535 filed on May 28, 2021, which claims the priority benefit of Chinese application serial No. 202010346100.5, filed on Apr. 27, 2020. The entirety of the above-mentioned patent applications is hereby incorporated by reference herein and made a part of this specification.

### TECHNICAL FIELD

The present invention relates to a data-knowledge-driven optimisation and control method for wastewater treatment process. Firstly, a wastewater treatment energy consumption and effluent water quality model is established based on the data-driven model to obtain a multi-objective optimisation function for wastewater treatment, and then a multi-objective particle swarm optimisation algorithm based on the evolution knowledge is adopted to optimise the concentration of dissolved oxygen S_{O} and nitrate nitrogen S_{NO} in the wastewater treatment process in order to reduce the operational energy consumption and improve the effluent Finally, the PID controller is used to track and control the concentration of dissolved oxygen S_{O} and nitrate nitrogen S_{NO}, and the invention can reduce the energy consumption of wastewater treatment and improve the quality of effluent water, which has high practical value.

### BACKGROUND TECHNOLOGY

Wastewater treatment is the process of removing organic matter from wastewater through a series of biochemical reactions and discharging the treated water. The wastewater treatment process is an indispensable part of the reuse of water resources, and plays an important role in saving water resources and maintaining the sustainable development of water resources.

Wastewater treatment process mechanism is complex, nonlinear and strong coupling characteristics are obvious, resulting in the wastewater treatment process is more difficult to optimise the control, and the wastewater treatment process energy consumption and effluent quality are two conflicting and coupled optimisation objectives, therefore, balancing the relationship between the energy consumption and effluent water quality in the wastewater treatment process is a kind of important research problem, in the wastewater treatment optimal control of energy consumption and effluent water quality target model establishment In the process, the mechanism model is difficult to be determined due to the different sewage treatment plants and their environments, so the design of the data-driven energy consumption and effluent water quality based model plays an important role in accurately describing the optimisation objectives of wastewater treatment; moreover, the collection of wastewater data in the wastewater treatment process requires a long time and the amount of the collected data is limited, which creates a certain limitation on the performance of the optimisation and control of the wastewater treatment process; Therefore, designing a reasonable optimisation method to optimise the control of dissolved oxygen S_{O} and nitrate nitrogen S_{NO} concentrations not only saves energy and ensures that the water quality meets the discharge standards, but also plays an important role in the stable and efficient operation of the wastewater treatment process.

The present invention designs a data-knowledge-driven optimal control method for wastewater treatment process, which mainly establishes a data-driven energy consumption and effluent water quality model, and obtains optimized setpoints of dissolved oxygen S_{O} and nitrate nitrogen S_{NO} concentrations using a knowledge-based multi-objective particle swarm algorithm, and realizes tracking control of dissolved oxygen S_{O} and nitrate nitrogen S_{NO} concentrations using a PID control method.

### SUMMARY

The present invention adopts the following technical scheme and realisation steps:
1. A data-knowledge-driven sewage treatment process optimisation and control method, the features of which include establishing a data-driven sewage treatment multi-objective optimisation model, designing a multi-objective particle swarm optimisation method based on evolutionary knowledge, and designing an optimisation setpoint tracking and control method, the specific steps of which are:
(1) Establishing a data-driven wastewater treatment target model
\textcircled{1} To establish a multi-objective optimisation model for wastewater treatment with the objectives of wastewater treatment energy consumption and effluent water quality:

$$min F ( t ) = [ {f}_{1} ( t ) , {f}_{2} ( t ) ] \qquad ( 1 )$$

where F(t) is the multi-objective optimisation model, f₁(t) is the energy consumption model at time t, and f₂(t) is the effluent water quality model at time t;

\textcircled{2} A data-driven wastewater treatment energy consumption and effluent water quality model was established based on the input variables of nitrate nitrogen S_{NO} at the end of the anaerobic section and dissolved oxygen S_{O} at the end of the aerobic section of the secondary treatment process, mixed solids suspended solids in effluent MLSS, and ammonia nitrogen in effluent S_{NH}:

$${f}_{1} ( t ) = {W}_{10} ( t ) + {\sum }_{i = 1}^{{I}_{1}} {W}_{1 i} ( t ) {B}_{1 i} ( t ) \qquad ( 2 )$$

$${f}_{2} ( t ) = {W}_{20} ( t ) + {\sum }_{i = 1}^{{I}_{2}} {W}_{2 i} ( t ) {B}_{2 i} ( t ) \qquad ( 3 )$$

where I₁∈[3, 30] is the number of radial basis kernel functions in the energy consumption model, I₂∈[3, 30] is the number of radial basis kernel functions in the effluent water quality model, W₁₀(t) is the output bias of the energy consumption model f₁(t), W₂₀(t) is the output bias of the effluent water quality model f₂(t), W_{1f}(t) is the weights of radial basis kernel functions in the energy consumption model, W_{2f}(t) is the weights of the weights of the radial basis kernel function in the effluent water quality model, B₁ᵢ(t) is the radial basis kernel function associated with the energy consumption model, and B₂ᵢ(t) is the radial basis kernel function associated with the effluent water quality model:

$${B}_{1 i} ( t ) = {e}^{- {‖ s ( t ) - {c}_{1 i} ( t ) ‖}^{2} / 2 {{σ}_{1 i} ( t )}^{2}} \qquad ( 4 )$$

$${B}_{2 i} ( t ) = {e}^{- {‖ s ( t ) - {c}_{2 i} ( t ) ‖}^{2} / 2 {{σ}_{2 i} ( t )}^{2}} \qquad ( 5 )$$

where s(t)=[S_{NO} (t), S_{O}(t), MLSS(t), S_{NH}(t)] is the input variable, c_{1f}(t) is the centre of the radial basis kernel function in the energy consumption model, and the interval of each variable in c₁ᵢ(t) is [−1, 1], c₂ᵢ(t) is the centre of the radial basis kernel function in the effluent quality model, and the interval of each variable in c₂ᵢ(t) is [−1, 1], σ₁ᵢ(t)∈[0, 3] is the width of the radial basis kernel function in the energy consumption model, and o₂ᵢ(t)∈[0, 3] is the width of the radial basis kernel function in the effluent water quality model;
(2) Design of a multi-objective particle swarm optimisation method based on evolutionary knowledge:
\textcircled{1} Set the total number of iterations K∈[50, 200] for multi-objective particle swarm optimisation, set the particle swarm size N∈[10, 100], k₀∈[2, 20] is the number of iterations for the particle information, and initialise the external archive A(0)=[ ];
\textcircled{2} Establish the optimisation objective of the multi-objective particle swarm optimisation algorithm: min F(t)=[f₁(t), f₂(t)];

\textcircled{3} Solve F(t), and record the convergence distribution state and diversity distribution state of each particle during the iteration process:

$${CS}_{n} ( k ) = \{ \begin{matrix}{\sum }_{m = 1}^{M} ( {f}_{n , m} ( k - 1 ) - {f}_{n , m} ( k ) ) , & if {x}_{n} ( k ) ≺ {x}_{n} ( k - 1 ) \\ 0 , & otherwise\end{matrix} \qquad ( 6 )$$

$${DS}_{n} ( t ) = {\sum }_{m = 1}^{M} {\sum }_{j = 1}^{N} \vert ( {f}_{n , m} ( k ) - {f}_{j , m} ( k ) \vert / N \qquad ( 7 )$$

where CSₙ(k) is the convergence distribution state of the nth particle at the kth iteration, f_{n,m}(k) is the mth objective value of the nth particle, M∈[1, 2] is the number of objective functions, xₙ(k) is the position vector of the nth particle, DSₙ(k) is the state of the diversity distribution, and |·| denotes the absolute value;
\textcircled{4} Establish indicators of convergence and diversity for individuals and populations, respectively:

$${IC}_{n} ( k ) = {\sum }_{u = k - {k}_{0}}^{k} {e}^{- \frac{{CS}_{n} ( k )}{k - u + 1}} \qquad ( 8 )$$

$$PC ( k ) = {\sum }_{n = 1}^{N} {IC}_{n} ( k ) \qquad ( 9 )$$

$${ID}_{n} ( k ) = {\sum }_{u = k - {k}_{0}}^{k} {e}^{- \frac{{DS}_{n} ( k )}{k - u + 1}} \qquad ( 10 )$$

$$PD ( k ) = {\sum }_{n = 1}^{N} {ID}_{n} ( k ) \qquad ( 11 )$$

where ICₙ(k) is the individual convergence metric, PC(k) is the population convergence metric, IDₙ(k) is the individual diversity metric, PD(k) is the population diversity metric, and u∈[k−k₀, k] is the number of iterations required for evolutionary knowledge;
\textcircled{5} Selecting population evolutionary strategies:
Case 1: When PC(k)>PC(k−1) and PD(k)>PD(k−1), the velocity and position update equations are

$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) \qquad ( 12 )$$

$${x}_{n , d} ( k + 1 ) = {x}_{n , d} ( k ) + {v}_{n , d} ( k + 1 ) \qquad ( 13 )$$

where ω is the inertia weight, which takes values in the range of [0.5, 0.9] in the wastewater treatment process, v_{n,d}(k) is the dth dimension of the nth particle velocity, x_{n,d}(k) is the particle position, p_{n,d}(k) is the individual optimal position, and g_{d}(k) is the population optimal position, r₁ and r₂ are the random values distributed in [0, 1], and c₁ is the individual optimal acceleration factor in the range of [1.5, 2.5], and c₂ is the global optimal acceleration factor, which takes values in the range of [1.5, 2.5] in the sewage treatment process;
Case 2: When PC(k)<PC(k−1) and PD(k)>PD(k−1), the velocity and position update equations are

$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) + {c}_{3} {r}_{3} {C}_{d} ( k ) \qquad ( 14 )$$

$${x}_{n , d} ( k + 1 ) = {x}_{n , d} ( k ) + {v}_{n , d} ( k + 1 ) \qquad ( 15 )$$

where r₃ is a random value distributed in [0, 1], c₃ is the convergence direction acceleration factor, which takes values in the range of [0.3, 0.5] in the wastewater treatment process, and C_{d}(k) is the direction of flight of the particles in the population with the maximum convergence;
Case 3: When PC(k)>PC(k−1) and PD(k)<PD(k−1), the velocity and position update equations are

$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) + {c}_{4} {r}_{4} {D}_{d} ( k ) \qquad ( 16 )$$

$${x}_{n , d} ( k + 1 ) = {x}_{n , d} ( k ) + {v}_{n , d} ( k + 1 ) \qquad ( 17 )$$

where r₄ is a random value distributed in [0,1], c₄ is the diversity direction acceleration factor, which takes values in the range of [0.3, 0.5] in the wastewater treatment process, and D_{d}(k) is the direction of flight of the particles with maximum diversity in the population;
Case 4: When PC(k)<PC(k−1) and PD(k)<PD(k−1), the velocity and position update equations are

$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) + \frac{1}{2} ( {c}_{3} {r}_{3} {C}_{d} ( k ) + {c}_{4} {r}_{4} {D}_{d} ( k ) ) \qquad ( 18 )$$

$${x}_{n , d} ( k + 1 ) = {x}_{n , d} ( k ) + {v}_{n , d} ( k + 1 ) \qquad ( 19 )$$

Case 5: PC(k)=PC(k−1) or PD(k)=PD(k−1), the velocity and position update equation is

$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) \qquad ( 20 )$$

$${x}_{n , d} ( k + 1 ) = \{ \begin{matrix}{x}_{d , m i n} + ( {x}_{d , ma x} - {x}_{d , m i n} ) \times U ( 0 , 1 ) , & {r}_{3} \leq {p}_{b} \\ {x}_{n , d} ( k ) , & {r}_{3} > {p}_{b}\end{matrix} \qquad ( 21 )$$

where U(0, 1) is a random value obeying a uniform distribution, x_{d,min} is the bounded minimum of the dth dimensional particle position, xₘᵢₙ=[x_{1,min}>x_{2,min}, . . . , x_{D,min}], x_{d,max} is the bounded maximum of the dth dimensional particle position, xₘₐₓ=[x_{1,max}, x_{2,max}, . . . , x_{D,max}], D∈[1, 4] is the dimension of the particle, r₅ is a random value distributed in [0,1], and p_{b} is the mutation probability:

$${p}_{b} = 0.5 - 0.5 \times \frac{k}{K} \qquad ( 22 )$$

\textcircled{6} The populations and archive A(k−1) produced by the kth iteration are merged to obtain J(k), and then the nondominated solutions are selected in J(k) to build A(k);
\textcircled{7} Determine whether the current iteration k is greater than or equal to K. If it is greater than or equal to K, go to step \textcircled{8}, if it is less than K, go to step \textcircled{3};
\textcircled{8} Select a non-dominated solution randomly in the archive A(K) as the optimisation setpoint a*(1)=aₕ(K) and aₕ(K)=[S_{NO}*(K), S_{O}*(K), MLSS*(K), S_{NH}*(K)], where S_{NO}*(K), S_{O}*(K), MLSS*(K) and S_{NH}*(K) are the nitrate-nitrogen optimisation setpoint, dissolved-oxygen optimisation setpoint, mixed-solid-suspension optimisation setpoint, and ammonia-nitrogen optimisation setpoint, respectively; save the optimisation setpoint;
(3) Optimising setpoint tracking control methods
\textcircled{1} A PID controller was used to track and control the nitrate nitrogen optimised setpoint S_{NO}*(K) and dissolved oxygen optimised setpoint S_{O}*(K) with the PID controller expression:

$$Δ z ( t ) = {K}_{p} [ e ( t ) + {H}_{l} {\int }_{0}^{t} e ( t ) dt + {H}_{d} \frac{de ( t )}{dt} ] \qquad ( 23 )$$

where Δz(t)=[ΔQₐ(t), ΔK_{La}5(t)]^{T} is the matrix of operating variables, ΔQₐ(t) is the amount of change in the internal circulation flow rate of wastewater treatment, and ΔK_{La}5(t) is the amount of change in the oxygen transfer coefficients of the 5th partition; Kₚ is the matrix of proportionality coefficients, Hₗ is the matrix of integral coefficients, and H_{d} is the matrix of differentiation coefficients; e(t)=y*(t)^{T}−y(t)^{T} is the control error, y*(t)=[S_{NO}*(t), S_{O}*(t)] is the optimisation setpoint at moment t, and y(t)=[S_{NO}(t), S_{O}(t)] is the actual output matrix;
\textcircled{2} The amount of change in the oxygen transfer coefficient of partition 5 and the amount of change in the internal recirculation return flow rate as are used as the output of the PID controller;
\textcircled{3}) The change in the oxygen transfer coefficient of partition 5, ΔK_{La}5(t), and the change in the internal recirculation return flow rate, ΔQₐ(t), are used as inputs to the wastewater treatment control system to control the nitrate nitrogen S_{NO} concentration and the dissolved oxygen S_{O} concentration.
(4) Data-knowledge driven control system design for wastewater treatment process optimisation

### \textcircled{1} Control Device Description:

PLC (Programmable Logic Controller): It is used to realise the logic control in the process of sewage treatment, with power failure protection, fault diagnosis and information protection to ensure the long-term stable operation of the system, and adopts the master-slave structure to communicate through the field bus to realise real-time monitoring and control.

Industrial controller (i.e. central processing system): used for monitoring and controlling the machines and equipment, production process, data parameters, etc. of the sewage treatment plant. It adopts fanless design with good dustproof, heat dissipation, anti-vibration and anti-interference functions, and is able to run stably in different environments. It is connected with PID controller through industrial controller to achieve the effective operation of optimised control system.

Blower: It is used for oxygen supply and water mixing to maintain the activity of microorganisms and ensure the normal progress of biochemical reaction. Single-stage centrifugal blower is selected, featuring large flow rate, stable pressure and high efficiency.

Return pump: control the return flow of sludge or mixed liquid, change the return flow of internal circulation according to the adjustment of frequency converter, control the concentration of nitrate nitrogen.

Frequency converter: used to adjust the motor speed to achieve energy saving and loss reduction. Selection of inverter adapted to high dynamic response, able to operate stably under different load conditions.

Sensor: real-time monitoring of dissolved oxygen concentration and nitrate nitrogen concentration and other data, which will be transmitted to the PLC.

Communication module: realise data communication between equipment, ensure data transmission and communication between PLC, sensor, inverter and industrial control machine.

### \textcircled{2} Control Equipment Operation:

Two processors are predefined in the whole system, a wastewater treatment target model processor based on step (1) of the present invention and a multi-objective particle swarm optimisation model processor based on step (2) of the present invention.

The sensors monitor the dissolved oxygen concentration, nitrate nitrogen concentration, mixed solid suspended solids in the effluent and ammonia nitrogen in the effluent in real time, respectively, and transmit the real-time monitored data to the central processing system (industrial computer) for processing, establish the energy consumption and effluent water quality model, and take the two models as the optimisation target to get the optimised setpoints of each parameter. Including: nitrate nitrogen optimisation set value S_{NO}*(K), dissolved oxygen optimisation set value S_{O}*(K).

The PID controller calculates the error based on the optimised setpoints of the nitrate nitrogen optimised setpoint S_{NO}*(K) the dissolved oxygen optimised setpoint S_{O}*(K) and the real-time monitoring values, and executes the PID control algorithm (i.e., step (3) of the present invention) and transmits the calculated control outputs (ΔKLa5(t) [symbol] ΔQa(t)) back to the PLC, which sends the control signals to the frequency converter.

The frequency converter receives the control signals sent by the PLC, and then controls and regulates the motor speed of the blower and the return pump to change the oxygen supply and the internal circulation return flow rate to control the dissolved oxygen and nitrate nitrogen concentration.

The sensor monitors the concentration of dissolved oxygen and nitrate nitrogen in real time, the data is fed back to the PID controller, which continuously makes control adjustments according to the real-time data to ensure that the concentration of dissolved oxygen and nitrate nitrogen reaches the optimised set value, thus realising the precise control of the wastewater treatment process, reducing the energy consumption and improving the quality of the effluent water.

The inventiveness of the present invention is mainly embodied in:
(1) the present invention for the sewage treatment process to reduce the sewage treatment energy consumption and enhance the sewage treatment effluent water quality of the two conflicting problems, the use of data-driven approach based on the establishment of the energy consumption and effluent water quality model, and the use of multi-objective particle swarm optimisation algorithms based on the evolutionary knowledge of the model optimisation, and finally, the use of PID control of nitrate nitrogen SNO and dissolved oxygen SO concentration tracking and control, in order to ensure that the effluent water quality meets the standard to achieve the purpose of reducing energy consumption, has high stability, and can achieve the reduction of sewage treatment costs;
In particular, note that the present invention only adopts a data-driven model based on a radial basis kernel function to establish an energy consumption and effluent water quality model for the sake of descriptive convenience, and uses a multi-objective particle swarm optimisation method based on evolutionary knowledge to optimise the concentration of nitrate nitrogen SNO and the concentration of dissolved oxygen SO, and will be other data-knowledge-driven optimisation algorithms based on data-driven modelling algorithms and knowledge-based optimisation algorithms and other data-knowledge-driven optimisation algorithms based on the same principle, control methods should all fall within the scope of the present invention.

### BRIEF DESCRIPTION OF DRAWINGS

FIG. 1 shows the framework of data-knowledge driven optimal control method.

FIG. 2 shows the tracking result of nitrate nitrogen for the optimal control method.

FIG. 3 shows the tracking error of nitrate nitrogen for the optimal control method.

FIG. 4 shows the tracking result of dissolved oxygen for the optimal control method.

FIG. 5 shows the tracking error of dissolved oxygen for the optimal control method.

FIG. 6 shows the flow chart of the system implementation process.

### SPECIFIC IMPLEMENTATION MODALITIES

(1) Establishment of a data-driven target-based model for wastewater treatment \textcircled{1} To establish a multi-objective optimisation model for wastewater treatment with the objectives of wastewater treatment energy consumption and effluent water quality:

$$min F ( t ) = [ {f}_{1} ( t ) , {f}_{2} ( t ) ] \qquad ( 1 )$$

where f₁(t) is the energy consumption model at time t, f₂(t) is the effluent water quality model at time t, and F(t) is the multi-objective optimisation model;
\textcircled{2} A data-driven wastewater treatment energy consumption and effluent water quality model was established based on the input variables of nitrate nitrogen S_{NO} at the end of the anaerobic section and dissolved oxygen S_{O} at the end of the aerobic section of the secondary treatment process, mixed solids suspended solids in effluent MLSS, and ammonia nitrogen in effluent S_{NH}:

$${f}_{1} ( t ) = {W}_{10} ( t ) + {\sum }_{i = 1}^{{I}_{1}} {W}_{1 i} ( t ) {B}_{1 i} ( t ) \qquad ( 2 )$$

$${f}_{2} ( t ) = {W}_{20} ( t ) + {\sum }_{i = 1}^{{I}_{2}} {W}_{2 i} ( t ) {B}_{2 i} ( t ) \qquad ( 3 )$$

where I₁=10 is the number of radial basis kernel functions in the energy consumption model, I₂=10 is the number of radial basis kernel functions in the effluent water quality model, W₁₀(t)=−1.20 is the output offset of f₁(t) in the energy consumption model, W₂₀(t)=0.34 is the output offset of f₂(t) in the effluent water quality model, W₁ᵢ(t)=−0.78 is the radial basis kernel function in the energy consumption model weights, W₂ᵢ(t)=1.62 is the weight of the radial basis kernel function in the effluent water quality model, B₁ᵢ(t) is the radial basis kernel function associated with the energy consumption model, and B₂ᵢ(t) is the radial basis kernel function associated with the effluent water quality model:

$${B}_{1 i} ( t ) = {e}^{- {‖ s ( t ) - {c}_{1 i} ( t ) ‖}^{2} / 2 {{σ}_{1 i} ( t )}^{2}} \qquad ( 4 )$$

$${B}_{2 i} ( t ) = {e}^{- {‖ s ( t ) - {c}_{2 i} ( t ) ‖}^{2} / 2 {{σ}_{2 i} ( t )}^{2}} \qquad ( 5 )$$

where s(t)=[S_{NO}(t), S_{O}(t), MLSS(t), S_{NH}(t)] is the input variable, s(0)=[1, 1.5, 15, 2.3], c₁ᵢ(t) is the centre of the radial basis kernel function in the energy model, c₁ᵢ(0)=[0.76, 0.45, 0.21, −0.33], c₂ᵢ(t) is the centre of the effluent water quality model in the centre of the radial basis kernel function, c₂ᵢ(0)=[0.82, 0.67, −0.29, 0.85], σ₁ᵢ(t) is the width of the radial basis kernel function in the energy consumption model, σ₁ᵢ(0)=0.62, and σ₂ᵢ(t) is the width of the radial basis kernel function in the effluent water quality model, σ₂ᵢ(0)=1.72;
(2) Design of a multi-objective particle swarm optimisation method based on evolutionary knowledge:
\textcircled{1} Set the total number of iterations for multi-objective particle swarm optimisation K=100, set the particle swarm size N=20, k₀=4 is the number of iterations for the particle information, and initialise the external archive A(0)=[ ];
\textcircled{2} Establish the optimisation objective of the multi-objective particle swarm optimisation algorithm: min F(t)=[f₁(t), f₂(t)];
\textcircled{3} F(t) is solved, and during the iteration process, the convergence distribution state and diversity distribution state of each particle are recorded:

$${CS}_{n} ( k ) = \{ \begin{matrix}{\sum }_{m = 1}^{M} ( {f}_{n , m} ( k - 1 ) - {f}_{n , m} ( k ) ) & , if {x}_{n} ( k ) ≺ {x}_{n} ( k - 1 ) \\ 0 , & otherwhise\end{matrix} \qquad ( 6 )$$

$${DS}_{n} ( t ) = {\sum }_{m = 1}^{M} {\sum }_{j = 1}^{N} \vert ( {f}_{n , m} ( k ) - {f}_{j , m} ( k ) \vert / N \qquad ( 7 )$$

where CSₙ(k) is the convergence distribution state of the nth particle at the kth iteration, f_{n,m}(k) is the mth objective value of the nth particle, M=2 is the number of objective functions, xₙ(k) is the position vector of the nth particle, DSₙ(k) is the state of diversity distribution, and |·| denotes the absolute value;
\textcircled{4} Indicators of convergence and diversity were established for individuals and populations, respectively:

$${IC}_{n} ( k ) = {\sum }_{u = k - {k}_{0}}^{k} {e}^{- \frac{{CS}_{n} ( k )}{k - u + 1}} \qquad ( 8 )$$

$$PC ( k ) = {\sum }_{n = 1}^{N} {IC}_{n} ( k ) \qquad ( 9 )$$

$${ID}_{n} ( k ) = {\sum }_{u = k - {k}_{0}}^{k} {e}^{- \frac{{DS}_{n} ( k )}{k - u + 1}} \qquad ( 10 )$$

$$PD ( k ) = {\sum }_{n = 1}^{N} {ID}_{n} ( k ) \qquad ( 11 )$$

where ICₙ(k) is the individual convergence metric, PC(k) is the population convergence metric, IDₙ(k) is the individual diversity metric, PD(k) is the population diversity metric, and u∈[k−k₀, k] is the number of iterations required for evolutionary knowledge;
\textcircled{5} Selecting population evolutionary strategies:
Case 1: When PC(k)>PC(k−1) and PD(k)>PD(k−1), the velocity and position update equations are

$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) \qquad ( 12 )$$

$${x}_{n , d} ( k + 1 ) = {x}_{n , d} ( k ) + {v}_{n , d} ( k + 1 ) \qquad ( 13 )$$

where ω is the inertia weight, which takes values in the range of [0.5, 0.9] in the wastewater treatment process, v_{n,d}(k) is the dth dimension of the nth particle velocity, x_{n,d}(k) is the particle position, p_{n,d}(k) is the individual optimal position, and g_{d}(k) is the population optimal position, r₁ and r₂ are the random values distributed in [0, 1], and c₁ is the individual optimal acceleration factor in the range of [1.5, 2.5], and c₂ is the global optimal acceleration factor, which takes values in the range of [1.5, 2.5] in the sewage treatment process;
Case 2: When PC(k)<PC(k−1) and PD(k)>PD(k−1), the velocity and position update equations are

$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) + {c}_{3} {r}_{3} {C}_{d} ( k ) \qquad ( 14 )$$

$${x}_{n , d} ( k + 1 ) = {x}_{n , d} ( k ) + {v}_{n , d} ( k + 1 ) \qquad ( 15 )$$

where r₃ is a random value distributed in [0, 1], c₃ is the convergence direction acceleration factor, which takes values in the range of [0.3, 0.5] in the wastewater treatment process, and C_{d}(k) is the direction of flight of the particles in the population with the maximum convergence;
Case 3: When PC(k)>PC(k−1) and PD(k)<PD(k−1), the velocity and position update equations are

$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) + {c}_{4} {r}_{4} {D}_{d} ( k ) \qquad ( 16 )$$

$${x}_{n , d} ( k + 1 ) = {x}_{n , d} ( k ) + {v}_{n , d} ( k + 1 ) \qquad ( 17 )$$

where r₄ is a random value distributed in [0,1], c₄ is the diversity direction acceleration factor, which takes values in the range of [0.3, 0.5] in the wastewater treatment process, and D_{d}(k) is the direction of flight of the particles with maximum diversity in the population;
Case 4: When PC(k)<PC(k−1) and PD(k)<PD(k−1), the velocity and position update equations are

$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) + \frac{1}{2} ( {c}_{3} {r}_{3} {C}_{d} ( k ) + {c}_{4} {r}_{4} {D}_{d} ( k ) ) \qquad ( 18 )$$

$${x}_{n , d} ( k + 1 ) = {x}_{n , d} ( k ) + {v}_{n , d} ( k + 1 ) \qquad ( 19 )$$

Case 5: PC(k)=PC(k−1) or PD(k)=PD(k−1), the velocity and position update equation is

$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) \qquad ( 20 )$$

$${x}_{n , d} ( k + 1 ) = \{ \begin{matrix}{x}_{d , m i n} + ( {x}_{d , ma x} - {x}_{d , m i n} ) \times U ( 0 , 1 ) , & {r}_{3} \leq {p}_{b} \\ {x}_{n , d} ( k ) , & {r}_{3} > {p}_{b}\end{matrix} \qquad ( 21 )$$

where U(0, 1) is a random value obeying a uniform distribution, x_{d,min} is the bounded minimum of the dth dimensional particle position, xₘᵢₙ=[x_{1,min}>x_{2,min}, . . . , x_{D,min}], x_{d,max} is the bounded maximum of the dth dimensional particle position, xₘₐₓ=[x_{1,max}, x_{2,max}, . . . , x_{D,max}], D∈[1, 4] is the dimension of the particle, r₅ is a random value distributed in [0,1], and p_{b} is the mutation probability:

$${p}_{b} = 0.5 - 0.5 \times \frac{k}{K} \qquad ( 22 )$$

\textcircled{6} The populations and archive A(k−1) produced by the kth iteration are merged to obtain J(k), and then the nondominated solutions are selected in J(k) to build A(k);
\textcircled{7} Determine whether the current iteration k is greater than or equal to K. If it is greater than or equal to K, go to step \textcircled{8}, if it is less than K, go to step \textcircled{3};
\textcircled{8} Select a non-dominated solution randomly in the archive A(K) as the optimisation setpoint a*(t)=aₕ(K) and aₕ(K)=[S_{NO}*(K), S_{O}*(K), MLSS*(K), S_{NH}*(K)], where S_{NO}*(K), S_{O}*(K), MLSS*(K) and S_{NH}*(K) are the nitrate-nitrogen optimisation setpoint, dissolved-oxygen optimisation setpoint, mixed-solid-suspension optimisation setpoint, and ammonia-nitrogen optimisation setpoint, respectively; save the optimisation setpoint;

### (3) Optimising Setpoint Tracking Control Methods

\textcircled{1} A PID controller was used to track and control the nitrate nitrogen optimised setpoint S_{NO}*(K) and dissolved oxygen optimised setpoint S_{O}*(K) with the PID controller expression:

$$Δ z ( t ) = {K}_{p} [ e ( t ) + {H}_{l} {\int }_{0}^{t} e ( t ) dt + {H}_{d} \frac{de ( t )}{dt} ] \qquad ( 23 )$$

where Δz(1)=[ΔQₐ(t), ΔK_{La}5(t)] Tis the matrix of operating variables, ΔQₐ(t) is the amount of change in the internal circulation flow rate of wastewater treatment, and ΔK_{La}5(t) is the amount of change in the oxygen transfer coefficients of the 5th partition; Kₚ is the matrix of proportionality coefficients, Hₗ is the matrix of integral coefficients, and H_{d} is the matrix of differentiation coefficients; e(t)=y*(t)^{T}−y(t)^{T} is the control error, y*(t)=[S_{NO}*(t), S_{O}*(t)] is the optimisation setpoint at moment t, and y(t)=[S_{NO}(t), S_{O}(t)] is the actual output matrix;
\textcircled{2} The amount of change in the oxygen transfer coefficient of partition 5 and the amount of change in the internal recirculation return flow rate as are used as the output of the PID controller;
\textcircled{3} The change in the oxygen transfer coefficient of partition 5, ΔK_{La}5(t), and the change in the internal recirculation return flow rate, ΔQₐ(t), are used as inputs to the wastewater treatment control system to control the nitrate nitrogen S_{NO} concentration and the dissolved oxygen S_{O} concentration.

### (4) Data-Knowledge Driven Control System Design for Wastewater Treatment Process Optimisation

### \textcircled{1} Control Device Description:

PLC (Programmable Logic Controller): It is used to realise the logic control in the process of sewage treatment, with power failure protection, fault diagnosis and information protection to ensure the long-term stable operation of the system, and adopts the master-slave structure to communicate through the field bus to realise real-time monitoring and control.

Industrial controller (i.e. central processing system): used for monitoring and controlling the machines and equipment, production process, data parameters, etc. of the sewage treatment plant. It adopts fanless design with good dustproof, heat dissipation, anti-vibration and anti-interference functions, and is able to run stably in different environments. It is connected with PID controller through industrial controller to achieve the effective operation of optimised control system.

Blower: It is used for oxygen supply and water mixing to maintain the activity of microorganisms and ensure the normal progress of biochemical reaction. Single-stage centrifugal blower is selected, featuring large flow rate, stable pressure and high efficiency.

Return pump: control the return flow of sludge or mixed liquid, change the return flow of internal circulation according to the adjustment of frequency converter, control the concentration of nitrate nitrogen.

Frequency converter: used to adjust the motor speed to achieve energy saving and loss reduction. Selection of inverter adapted to high dynamic response, able to operate stably under different load conditions.

Sensor: real-time monitoring of dissolved oxygen concentration and nitrate nitrogen concentration and other data, which will be transmitted to the PLC.

Communication module: realise data communication between equipment, ensure data transmission and communication between PLC, sensor, inverter and industrial control machine.

### \textcircled{2} Control Equipment Operation:

Two processors are predefined in the whole system, a wastewater treatment target model processor based on step (1) of the present invention and a multi-objective particle swarm optimisation model processor based on step (2) of the present invention.

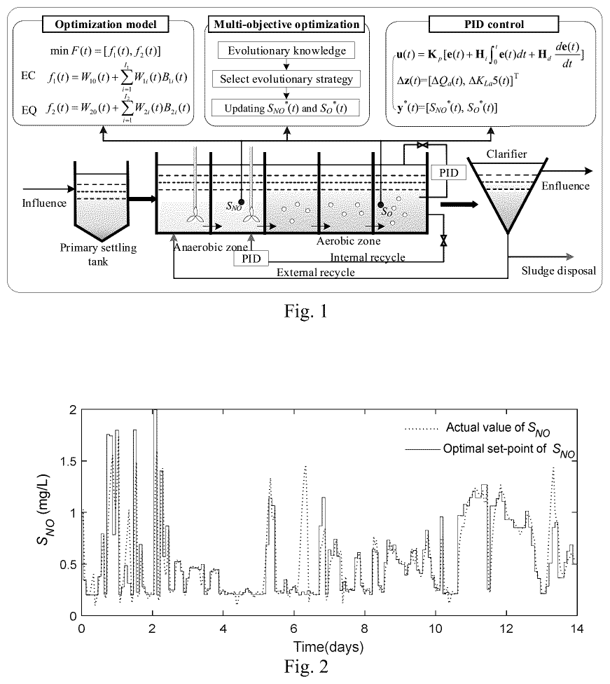

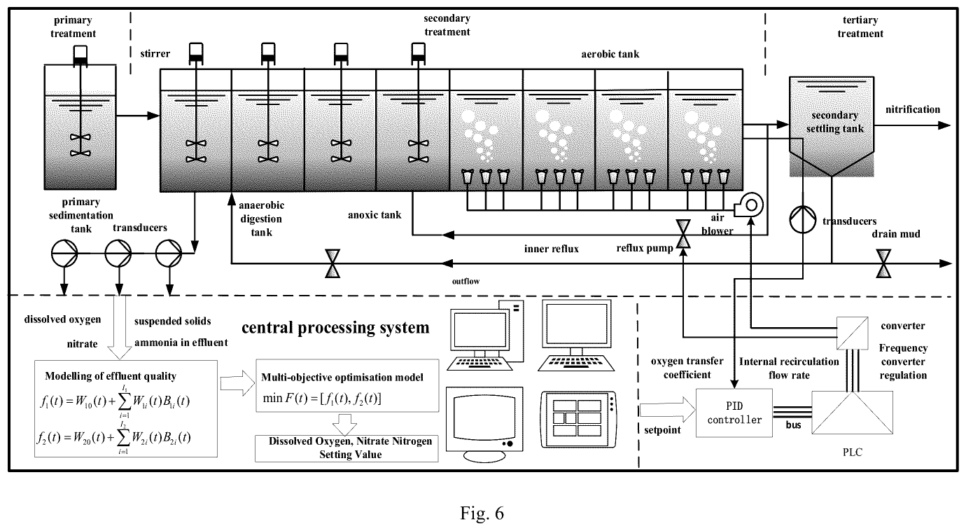

The sensors monitor dissolved oxygen concentration, nitrate nitrogen concentration, effluent mixed suspended solids (MLSS) and effluent ammonia nitrogen in real time, respectively. The effluent mixed suspended solids (solid mixture) concentration is usually monitored at a location between the primary sedimentation tank of the primary treatment process and the secondary treatment process, for example, at any of the anaerobic digestion tank(s) as shown in FIG. 6, or at any of the anaerobic digestion tank(s) in an anaerobic zone as shown in FIG. 1. The secondary treatment process usually includes one or more anaerobic digestion tank, one or more anoxic tank and one or more aerobic tank (as shown in FIG. 6), or includes an anaerobic zone and an aerobic zone (as shown FIG. 1). The nitrate nitrogen is usually monitored at the outflow of the secondary sedimentation tank in the tertiary treatment process as shown in FIG. 6, or at the outflow of the clarifier as shown in FIG. 1. The effluent ammonia nitrogen is usually monitored at the output end of the secondary treatment process, for example, at any of the aerobic tank(s) in the aerobic zone. Corresponding sensors are positioned in corresponding locations. The real-time monitored (measured) data are transmitted to a central processing system (e.g., an industrial computer) for processing, establishing energy consumption and effluent water quality models, and using the two models as optimisation targets to obtain the optimised set values of each parameter. Including: nitrate nitrogen optimisation set value Sko*(K), dissolved oxygen optimisation set value S_{O}*(K).

The PID controller calculates the error based on the optimised setpoints of nitrate nitrogen optimised setpoint S_{NO}(K), dissolved oxygen optimised setpoint S_{O}*(K) and the real-time monitoring value, and executes the PID control algorithm (i.e. step (3) of the present invention), so that when the actual dissolved oxygen concentration is lower than the setpoints (S_{O}<S_{O}*(K)), the amount of the oxygen supply needs to be increased (the speed of the blower is increased) in order to raise the dissolved oxygen concentration; when the actual dissolved oxygen concentration is higher than the set value (S_{O}>S_{O}*(K), it is necessary to reduce the amount of oxygen supply (reduce the speed of the blower) in order to reduce the dissolved oxygen concentration. When the actual nitrate nitrogen concentration is higher than the set value (S_{NO}>S_{NO}*(K)), it is necessary to increase the internal circulation flow rate (increase the speed of reflux pump) to enhance the denitrification process and reduce the nitrate nitrogen concentration; when the actual nitrate nitrogen concentration is lower than the set value (S_{NO}<S_{NO}*(K), it is necessary to reduce the internal circulation flow rate (reduce the speed of reflux pump) to weaken the denitrification process and avoid the nitrate nitrogen concentration is too low. And the calculated control outputs (ΔKLa5(t) and ΔQa(t)) are sent back to the PLC, which sends the control signals to the inverter. The frequency converter is a stand-alone device that first receives the control signals from the PLC and then regulates the speed of the blower or return pump based on these signals. Therefore, the signal flow is: PLC→frequency converter→blower or return pump.

The frequency converter receives the control signals sent by the PLC, and then controls and regulates the motor speed of the blower and the return pump to change the oxygen supply and the internal circulation return flow rate to control the dissolved oxygen and nitrate nitrogen concentration.

The sensor monitors the concentration of dissolved oxygen and nitrate nitrogen in real time, the data is fed back to the PID controller, which continuously makes control adjustments according to the real-time data to ensure that the concentration of dissolved oxygen and nitrate nitrogen reaches the optimised set value, thus realising the precise control of the wastewater treatment process, reducing the energy consumption and improving the quality of the effluent water.

FIG. 1 shows a wastewater treatment system. The wastewater treatment system includes a primary settling tank, an anaerobic zone, an aerobic zone and a clarifier arranged sequentially. The primary settling tank receives and settles the wastewater to be treated. After primary settling, the wastewater is introduced to an anaerobic tank in the anaerobic zone. The anaerobic zone may have one or more anaerobic tanks connected in series, a stirrer can be provided in the anaerobic tank. Nitrate nitrogen S_{NO} concentration in the anaerobic zone is measured via a S_{NO} sensor for real-time monitoring of nitrate nitrogen S_{NO} concentration. The S_{NO} sensor can be provided in the anaerobic tank, and can be positioned at the downstream end of the anaerobic zone, the upstream end of the anaerobic zone, or any location in between. The wastewater exiting from the downstream end of the anaerobic zone enters the aerobic zone, the aerobic zone may have one or more aerobic tanks connected in series. Dissolved oxygen S_{O} concentration in the aerobic zone is measured via a S_{O} sensor for real-time monitoring of dissolved oxygen S_{O} concentration. The S_{O} sensor can be provided in the aerobic tank, and can be positioned at the downstream end of the aerobic zone, the upstream end of the aerobic zone, or any location in between. After treatment in the aerobic zone, the wastewater is introduced in the clarifier to obtain an enfluence (the treated wastewater) and sludge disposal, a portion of the wastewater (internal recycle) can be recycled back to the anaerobic zone to adjust nitrate nitrogen S_{NO} concentration. A portion of the enfluence of the clarifier (external recycle) can be recycled back to the anaerobic zone from the bottom of the clarifier to adjust nitrate nitrogen Sto concentration of nitrate nitrogen S_{NO} concentration.

In a similar wastewater treatment system shown in FIG. 6, there is an anoxic zone between the anaerobic zone and the aerobic zone, containing one or more anoxic tanks connected in series. In this case, a portion of the wastewater (internal recycle) exiting from the aerobic zone can be recycled back to the anoxic tank to adjust nitrate nitrogen S_{NO} concentration, and a portion of the enfluence (external recycle) of the secondary settling tank can be recycled back to the anaerobic tank from the bottom of the secondary settling tank. An air blower is provided to pump air into the aerobic tank for oxygen supply and water mixing to maintain the activity of microorganisms and ensure the normal progress of biochemical reaction. A single-stage centrifugal blower can be used, which has the features of large flow rate, stable pressure and high efficiency.

The above mentioned internal recycle and external recycle are controlled by a return pump, which controls the internal/external recycle flow of mixed liquid or sludge, change the internal and/or external recycle flow so as to control the concentration of nitrate nitrogen.

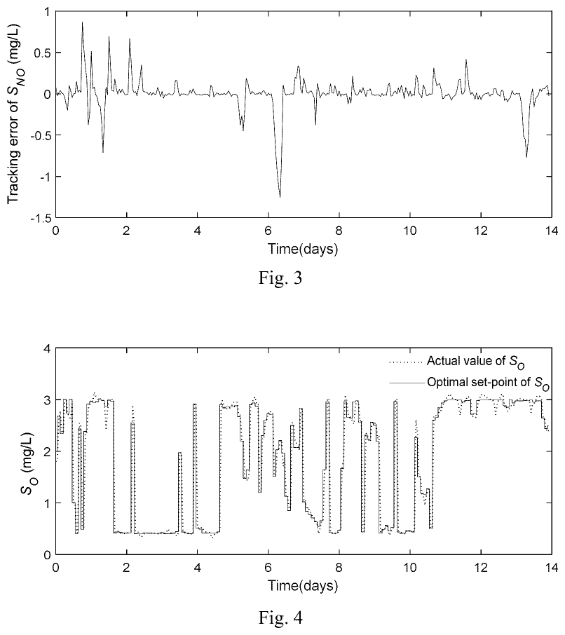

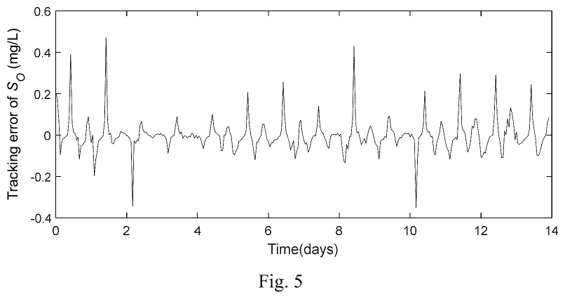

A data-knowledge driven wastewater treatment process optimisation control system based on the output results of nitrate nitrogen S_{NO} concentration and dissolved oxygen S_{O} concentration, FIG. 2 is the nitrate nitrogen result graph, where the solid line is the control output and the dashed line is the actual output, the horizontal axis: time in days, the vertical axis: nitrate nitrogen concentration in milligrams per litre, FIG. 3 is the nitrate nitrogen tracking error graph, the horizontal axis: time in days, the vertical axis: nitrate nitrogen concentration in mg/l, FIG. 4 is a graph of dissolved oxygen results, where the solid line is the control output and the dashed line is the actual output, horizontal axis: time in days, vertical axis: nitrate nitrogen concentration in mg/l, FIG. 5 is a graph of the tracking error of dissolved oxygen, horizontal axis: time in days, vertical axis: nitrate nitrogen concentration in mg/l.

1. A data-knowledge-driven optimisation and control method for a wastewater treatment process in a wastewater treatment system, wherein:
the wastewater treatment system comprises a primary settling tank, an anaerobic digestion tank, an aerobic tank and a secondary settling tank arranged sequentially in fluid communication;
the data-knowledge-driven optimisation and control method comprises establishing a data-driven multi-objective optimisation model, designing a multi-objective particle swarm optimisation method based on evolutionary knowledge, and designing an optimisation setpoint tracking and control method, specific steps of the data-knowledge-driven optimisation and control method comprise:
(1) establishing a data-driven wastewater treatment target model:
\textcircled{1} taking energy consumption and effluent water quality as objectives to establish a multi-objective optimisation model for the wastewater treatment process:
$$min F ( t ) = [ {f}_{1} ( t ) , {f}_{2} ( t ) ] \qquad ( 1 )$$
where F(t) is the data-driven multi-objective optimisation model, f₁(t) is an energy consumption model at time t, and f₂(t) is an effluent water quality model at time t;
\textcircled{2} establishing a data-driven energy consumption and effluent water quality model based on real-time measured input variables of nitrate nitrogen S_{NO} at the anaerobic digestion tank and dissolved oxygen S_{O} at the aerobic tank, effluent mixed suspended solids (MLSS), and ammonia nitrogen in effluent S_{NH}:
$${f}_{1} ( t ) = {W}_{10} ( t ) + {\sum }_{i = 1}^{{I}_{1}} {W}_{1 i} ( t ) {B}_{1 i} ( t ) \qquad ( 2 )$$
$${f}_{2} ( t ) = {W}_{20} ( t ) + {\sum }_{i = 1}^{{I}_{2}} {W}_{2 i} ( t ) {B}_{2 i} ( t ) \qquad ( 3 )$$
where I₁∈[3, 30] is the number of radial basis kernel functions in the energy consumption model, I₂∈[3, 30] is the number of radial basis kernel functions in the effluent water quality model, W₁₀(t) is an output bias of the energy consumption model f₁(t), W₂₀(t) is an output bias of the effluent water quality model f₂(t), W_{1f}(t) is weights of the radial basis kernel functions in the energy consumption model, W_{2f}(t) is weights of the radial basis kernel function in the effluent water quality model, B_{1f}(t) is the radial basis kernel function associated with the energy consumption model, and B_{2f}(t) is the radial basis kernel function associated with the effluent water quality model:
$${B}_{1 i} ( t ) = {e}^{- {‖ s ( t ) - {e}_{1 i} ( t ) ‖}^{2} / 2 {{σ}_{1 i} ( t )}^{2}} \qquad ( 4 )$$
$${B}_{2 i} ( t ) = {e}^{- {‖ s ( t ) - {e}_{2 i} ( t ) ‖}^{2} / 2 {{σ}_{2 i} ( t )}^{2}} \qquad ( 5 )$$
where s(t)=[S_{NO}(t), S_{O}(t), MLSS(t), S_{NH}(t)] is the input variables, c₁ᵢ(t) is a centre of the radial basis kernel function in the energy consumption model, and an interval of each variable in c₁ᵢ(t) is [−1, 1], c₂ᵢ(t) is a centre of the radial basis kernel function in the effluent quality model, and an interval of each variable in c₂ᵢ(t) is [−1, 1], σ₁ᵢ(t)∈[0, 3] is a width of the radial basis kernel function in the energy consumption model, and σ₂ᵢ(t)∈[0, 3] is a width of the radial basis kernel function in the effluent water quality model;
(2) design the multi-objective particle swarm optimisation method based on evolutionary knowledge:
\textcircled{1} set a total number of iterations K∈[50, 200] for multi-objective particle swarm optimisation, set a particle swarm size N∈[10, 100], k₀∈[2, 20] is the number of iterations for particle information, and initialise an external archive A(0)=[ ];
\textcircled{2} establish an optimisation objective of a multi-objective particle swarm optimisation algorithm: min F(t)=[f₁(t), f₂(t)];
\textcircled{3} solve F(t), and record convergence distribution state and diversity distribution state of each particle during an iteration process:
$${CS}_{n} ( k ) = \{ \begin{matrix}{\sum }_{m = 1}^{M} ( {f}_{n , m} ( k - 1 ) - {f}_{n , m} ( k ) ) , & if {x}_{n} ( k ) ≺ {x}_{n} ( k - 1 ) \\ 0 , & otherwise\end{matrix} \qquad ( 6 )$$
$${DS}_{n} ( t ) = {\sum }_{m = 1}^{M} {\sum }_{j = 1}^{N} \vert ( {f}_{n , m} ( k ) - {f}_{j , m} ( k ) \vert / N \qquad ( 7 )$$
where CSₙ(k) is the convergence distribution state of nth particle at the kth iteration, f_{n,m}(k) is mth objective value of the nth particle, M∈[1, 2] is the number of objective functions, xₙ(k) is a position vector of the nth particle, DSₙ(k) is the diversity distribution state, and |·| denotes an absolute value;
\textcircled{4} establish indicators of convergence and diversity for individuals and populations, respectively:
$${IC}_{n} ( k ) = {\sum }_{u = k - {k}_{0}}^{k} {e}^{- \frac{{CS}_{n} ( k )}{k - u + 1}} \qquad ( 8 )$$
$$PC ( k ) = {\sum }_{n = 1}^{N} {IC}_{n} ( k ) \qquad ( 9 )$$
$${ID}_{n} ( k ) = {\sum }_{u = k - {k}_{0}}^{k} {e}^{- \frac{{DS}_{n} ( k )}{k - u + 1}} \qquad ( 10 )$$
$$PD ( k ) = {\sum }_{n = 1}^{N} {ID}_{n} ( k ) \qquad ( 11 )$$
where ICₙ(k) is an individual convergence metric, PC(k) is a population convergence metric, IDₙ(k) is an individual diversity metric, PD(k) is a population diversity metric, and u∈[k−k₀, k] is the number of iterations required for evolutionary knowledge;
\textcircled{5} selecting population evolutionary strategies:
Case 1: when PC(k)>PC(k−1) and PD(k)>PD(k−1), velocity and position update equations are
$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) \qquad ( 12 )$$
$${x}_{n , d} ( k + 1 ) = {x}_{n , d} ( k ) + {v}_{n , d} ( k + 1 ) \qquad ( 13 )$$
where ω is an inertia weight, which takes values in the range of [0.5, 0.9] in the wastewater treatment process, v_{n,d}(k) is dth dimension of nth particle velocity, x_{n,d}(k) is particle position, p_{n,d}(k) is individual optimal position, and g_{d}(k) is population optimal position, r₁ and r₂ are random values distributed in [0, 1], and c₁ is individual optimal acceleration factor in the range of [1.5, 2.5], and c₂ is global optimal acceleration factor, which takes values in the range of [1.5, 2.5] in the wastewater treatment process;
Case 2: when PC(k)<PC(k−1) and PD(k)>PD(k−1), the velocity and position update equations are
$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) + {c}_{3} {r}_{3} {C}_{d} ( k ) \qquad ( 14 )$$
$${x}_{n , d} ( k + 1 ) = {x}_{n , d} ( k ) + {v}_{n , d} ( k + 1 ) \qquad ( 15 )$$
where r₃ is a random value distributed in [0, 1], c₃ is a convergence direction acceleration factor, which takes values in the range of [0.3, 0.5] in the wastewater treatment process, and C_{d}(k) is a direction of flight of the particles in the population with the maximum convergence;
Case 3: when PC(k)>PC(k−1) and PD(k)<PD(k−1), the velocity and position update equations are:
$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) + {c}_{4} {r}_{4} {D}_{d} ( k ) \qquad ( 16 )$$
$${x}_{n , d} ( k + 1 ) = {x}_{n , d} ( k ) + {v}_{n , d} ( k + 1 ) \qquad ( 17 )$$
where r₄ is a random value distributed in [0,1], c₄ is a diversity direction acceleration factor, which takes values in the range of [0.3, 0.5] in the wastewater treatment process, and D_{d}(k) is a direction of flight of the particles with maximum diversity in the population;
Case 4: when PC(k)<PC(k−1) and PD(k)<PD(k−1), the velocity and position update equations are:
$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) + \frac{1}{2} ( {c}_{3} {r}_{3} {C}_{d} ( k ) + {c}_{4} {r}_{4} {D}_{d} ( k ) ) \qquad ( 18 )$$
$${x}_{n , d} ( k + 1 ) = {x}_{n , d} ( k ) + {v}_{n , d} ( k + 1 ) \qquad ( 19 )$$
Case 5: when PC(k)=PC(k−1) or PD(k)=PD(k−1), the velocity and position update equation is:
$${v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) \qquad ( 20 )$$
$${x}_{n , d} ( k + 1 ) = \{ \begin{matrix}{x}_{d , min} + ( {x}_{d , max} - {x}_{d , min} ) \times U ( 0 , 1 ) , & {r}_{3} \leq {p}_{b} \\ {x}_{n , d} ( k ) , & {r}_{3} > {p}_{b}\end{matrix} \qquad ( 21 )$$
where U(0, 1) is a random value obeying a uniform distribution, x_{d,min} is a bounded minimum of dth dimensional particle position, xₘᵢₙ=[x_{1,min}>x_{2,min}, . . . , x_{D,min}], x_{d,max} is a bounded maximum of the dth dimensional particle position, xₘₐₓ=[x_{1,max}, x_{2,max}, . . . , x_{D,max}], D∈[1, 4] is the dimension of the particle, r₅ is a random value distributed in [0,1], and p_{b} is a mutation probability:
$${p}_{d} = 0.5 - 0.5 \times \frac{k}{K} \qquad ( 22 )$$
\textcircled{6} populations and archive A(k−1) produced by the kth iteration are merged to obtain J(k), and then nondominated solutions are selected in J(k) to build A(k);
\textcircled{7} determine whether current iteration k is greater than or equal to K; if the current iteration k is greater than or equal to K, go to step \textcircled{8}, if the current iteration k is less than K, go to step \textcircled{3};
\textcircled{8} select a non-dominated solution randomly in archive A(K) as an optimisation setpoint a*(t)=aₕ(K) and aₕ(K)=[S_{NO}*(K), S_{O}*(K), MLSS*(K), S_{NH}*(K)], where S_{NO}*(K), S_{O}*(K), MLSS*(K) and S_{NH}*(K) are nitrate-nitrogen optimisation setpoint, dissolved-oxygen optimisation setpoint, effluent mixed suspended solids optimisation setpoint, and ammonia-nitrogen optimisation setpoint, respectively; save the optimisation setpoint;
(3) optimising setpoint tracking control methods
\textcircled{1} a PID controller is used to track and control the nitrate nitrogen optimisation setpoint S_{NO}*(K) and the dissolved oxygen optimisation setpoint S_{O}*(K) with a PID controller expression:
$$Δ z ( t ) = {K}_{p} [ e ( t ) + {H}_{t} {\int }_{0}^{t} e ( t ) dt + {H}_{d} \frac{de ( t )}{dt} ] \qquad ( 23 )$$
where Δz(t)=[ΔQₐ(t), ΔK_{La}5(t)]^{T} is a matrix of operating variables, ΔQₐ(t) is an amount of change in internal circulation flow rate of the wastewater treatment process, and ΔK_{La}5(t) is an amount of change in oxygen transfer coefficients of 5th partition; Kₚ is a matrix of proportionality coefficients, Hₗ is a matrix of integral coefficients, and H_{d} is a matrix of differentiation coefficients; e(t)=y*(t)^{T}−y(t)^{T} is a control error, y*(t)=[S_{NO}*(t), S_{O}*(t)] is an optimisation setpoint at moment t, and y(t)=[S_{NO}(t), S_{O}(t)] is an actual output matrix;
\textcircled{2} the amount of change in the oxygen transfer coefficient of partition 5 and the amount of change in the internal recirculation return flow rate are used as an output of the PID controller;
\textcircled{3} the change in the oxygen transfer coefficient of partition 5, ΔK_{La}5(t), and the change in the internal recirculation return flow rate, ΔQₐ(t), are used as inputs to a wastewater treatment control system to control the nitrate nitrogen S_{NO} concentration and the dissolved oxygen S_{O} concentration;
(4) data-knowledge driven control for the wastewater treatment process
the PID controller calculates an deviation based on the nitrate nitrogen optimization setpoint S_{NO}*(K), the dissolved oxygen optimization setpoint S_{O}*(K), the real-time measured input variables of nitrate nitrogen S_{NO} and dissolved oxygen S_{O}, and executes a PID control algorithm, so that when S_{O}<S_{O}*(K), oxygen supply is increased to raise S_{O}, when (S_{O}>S_{O}*(K)), the oxygen supply is reduced to lower S_{O}: when S_{NO}>S_{NO}*(K), an internal circulation flow is increased to enhance a denitrification process and reduce S_{NO}, when S_{NO}<S_{NO}*(K), the internal circulation flow rate is reduced to weaken the denitrification process and increase S_{NO}.
